(19) United States
(12) Patent Application Publication
(10) Pub. No.: US 2023/0232876 A1
(43) Pub. Date: Jul. 27, 2023

(54) STARCH AND SHELF-STABLE SAUCE MEAL COMPOSITIONS, KITS, AND METHODS

(71) Applicant: Aly Gamay, McLean, VA (US)

(72) Inventor: Aly Gamay, McLean, VA (US)

(73) Assignee: Aly Gamay, McLean, VA (US)

(21) Appl. No.: 17/580,881

(22) Filed: Jan. 21, 2022

(51) Int. Cl. A23L 7/10; A23L 27/00

(52) U.S. Cl. CPC A23L 7/198; A23L 27/82

(57) ABSTRACT

Shelf-stable meal compositions and kits and their methods of use are described.

### FIELD OF INVENTION

The present invention relates to a shelf-stable composition of a starch base and acidified sauce. More particularly, the current invention relates to a meal comprising noodle, rice, or potato starch product and an ambient temperature shelf-stable acidified cheese product that does not exhibit any acid astringency or acid sensation when prepared for consumption.

### BACKGROUND

Meal kits are popular due to their ease of preparation, desirable taste, and nutritional value. Time pressed consumers often rely on dry boxed meals to save time on grocery shopping, cooking, and cleaning up. Many dry boxed meals, such as microwavable macaroni and cheese and pasta with marinara sauce, come with disposable containers for heating and serving.

Shelf-stable sauces, such as those packaged in pouches, are often used in the food industry as components in food kits, such as meal kits, side dishes, and snack kits. Generally, food kits can include at least one pre-packaged food component or ingredient and the sauce component. The pre-packaged food components can include, for example, dried pasta, refrigerated pasta, rice, potatoes, dehydrated vegetables, refrigerated vegetables, dough products, pizza-making components, and combinations thereof. The food component is prepared either separately or simultaneously with the sauce component. Side dishes such as, for example, potato kits can incorporate cheese sauces to be added into a potato casserole as an ingredient and/or added to the exterior of the casserole for pleasing visual attributes or additional flavor.

Meal kits, including cheese sauces, are widely used for convenience and ease of preparation. If the cheese quality is compromised, the entire meal kit would be impacted. Therefore, attention is focused more on the quality of the cheese component than on the starch component. Cheese sauces may be mixed with a variety of starch products such as wheat, vegetable, and gluten free pasta, macaroni, and noodles; rice- or potato-based components to produce popular macaroni and cheese kits, pasta and tomato-based sauces, potato, and cheese au gratin type products.

Cheese and cheese products are highly nutritious and popular in a variety of prepared foods and snack items. Several categories of hard, semi-soft, and soft cheeses exist. Natural cheeses, e.g., cheddar, mozzarella, Romano, blue, Parmesan, are produced without further processing or addition of other ingredients, while pasteurized process cheese, e.g., American, spread and food, entails the addition of other ingredients and pasteurization. Natural and pasteurized process cheeses have standard compositional identities. For example, standards of identity for pasteurized process cheese spread include cheese content of at least 51% by weight, milk fat content of at least 20% by weight, and moisture content of 44-60% by weight. See 21 CFR 133.179. On the other hand, cheese substitutes, cheese sauces, cheese products, and cheese analogs made from either dairy and/or nondairy ingredients have no such identity standards.

Typically, cheese is not shelf-stable at room temperature and requires special packaging and refrigeration during all phases of shipping, handling, and marketing. Otherwise, spoilage will take place. Such rigid and exacting requirements during packaging and refrigeration limit the scope in which cheese can be utilized, particularly in industrial applications where many production facilities may lack refrigerated storage space. Furthermore, such a strict requirement for refrigeration limits distribution of cheese and related products in underdeveloped and developing countries where refrigeration facilities are not commonplace. Further limitations exist where storage precludes effective refrigeration.

Shelf-stable cheese sauce products in the marketplace are currently produced utilizing one of four processes: (1) pasteurization and hot-fill; (2) ultra-heat treatment (“UHT”) and aseptic filling/packaging; (3) retorting; or (4) acidification.

Pasteurization and hot-filling are used for heating liquids, such as milk and other dairy products, to destroy most viruses and harmful organisms such as bacteria, protozoa, molds, and yeasts, but are not used as a sterilization process to kill all pathogens. Pasteurization and hot-filling are typically carried out at temperatures below boiling so as not to irreversibly aggregate, or curdle, dairy products. Pasteurization and hot-filling are commonly used in cheese sauce processing and include heating the cheese sauce to at least 150° F. without reaching boiling and holding it at that temperature for about 30 seconds.

Most cheese sauces for meal applications are produced using a model developed by Tanaka et al. for pasteurized process cheese spreads. See Tanaka et al., J. of Food Protection, 49(7):526-531 (1986). The model predicts the safety of shelf-stable pasteurized process cheese spreads using the parameters of disodium phosphate (Na₂PO₄), sodium chloride (NaCl), pH, water activity (a_{w}), moisture content, and lactic acid levels to inhibit Clostridium botulinum (C. botulimum). The model does not apply, however, to products that fall outside pasteurized process cheese spreads’ standards of identity (e.g., at least 51% cheese, at least 20% milk fat, 44% - 60% moisture). Cheese sauces that vary from the formulations and conditions evaluated in Tanaka et al. must verify safety through microbial challenge studies or retort process validation, followed by FDA filing.

UHT and aseptic filling/packaging can be used on cheese sauces with lower levels of cheese. UHT and aseptic filling/packaging confer commercial sterility by heating the cheese sauce to at least 250° F. and holding it at that temperature for about 2 to 5 seconds. Although UHT and aseptic filling/packaging have been highly successful in perishable-prone products, high capital and maintenance costs are often associated with UHT and aseptic filling/packaging. Furthermore, unacceptable cooked notes are produced due to the high processing temperature.

Retorting sterilizes food by first sealing the food in a package before heating it to a high temperature. Like UHT and aseptic filling/packaging, retorting’s high processing temperature can cause Maillard reactions which lead to an undesirable brown color and cooked notes, as well as denaturation and protein precipitation, which lead to an unpleasant grainy or chalky texture in dairy products.

Cheese sauces today generally contain from about 20% to about 50% by weight of cheese to achieve the product attributes described above. (Cheese products with 51% or greater cheese content are characterized as “spreads” or “foods” rather than “sauces.”) With these relatively high levels of cheese in current sauces, the cost of cheese is critical in the cost of manufacturing the cheese sauce. As the price of cheese rises, the cost of the cheese sauce also rises. An effective method of lowering the manufacturing costs of cheese sauces is to lower the cheese content. However, with the processes discussed above, reducing the cheese content to below 51% by weight can require high capital and maintenance cost, result in products with compromised safety or organoleptic properties, or necessitate additional safety studies, FDA filings, and attendant costs. Additionally, once their packages are opened, products made by the aforesaid processes must be refrigerated or brought to and held at an elevated temperature to remain safe.

As an alternative to the processes described above, cheese sauces may be processed using acidification to produce acidified foods. 21 CFR 114 defines acidified foods as low-acid foods to which acid(s) or acid food(s) are added and which have a water activity (a_{w}) greater than 0.85 and a finished equilibrium pH of 4.6 or below. The purpose of 21 CFR 114 is to ensure safety from harmful bacteria or their toxins, especially the deadly C. botulinum. This can be accomplished by appropriate processing methods, such as cooking the food at the proper temperature for sufficient times, adequately acidifying the food, or controlling water activity. C. botulinum exists widely in the environment. Under certain conditions, C. botulinum can grow in foods and produce a powerful toxin that affects the nervous system. C. botulinum can grow in foods that: are packaged in the absence of oxygen, have favorable pH and temperature, and contain water and nutrients necessary for its growth. Low-acid canned foods provide such favorable environments. When low-acid foods are acidified to a pH of 4.6 or below, according to Current Good Manufacturing Practices (cGMP), 21 CFR 110, inhibition of the growth of C. botulinum is assured. Because of the high levels of acid addition needed to achieve a pH of 4.6 or below, the likelihood of an objectionable acidic or sour taste developing in processed food has limited adoption of acidification.

In summary, there are a considerable number of deficiencies and problems in the art relating to preparing economical shelf-stable cheese sauces to be combined with starch products. Most such problems and deficiencies relating to shelf stability can be attributed to the cheese sauce composition and/or the method by which it is prepared. There is a need for cheese sauces, products, and compositions having the following attributes: (1) shelf-stable at room temperature until their containers or packages are opened; (2) acceptable organoleptic characteristics (e.g., body, texture, flavor, smell, color, appearance) when combined with the cooked starch component; (3) affordable to consumers; and/or (4) economical to manufacture with low capital investment.

### OBJECTS

It is, therefore, an object of this invention to overcome the problems and deficiencies of the art related to providing economical meal kits containing an acidified sauce and a neutralizing or acid-reducing starch component.

It is an object of the present invention to provide a shelf-stable cheese sauce with high moisture content and a pH of about 4.6 or lower and does not produce an astringent taste when combined with a neutralizing starch component.

It is another object of the present invention to provide a shelf-stable cheese sauce with high acidity that exhibits acceptable organoleptic qualities when combined with pasta.

It is a further object of the current invention to provide a highly acidic tomato-based sauce that does not taste sour and provides a pleasant eating experience when added to pasta.

It is another object of the present invention to provide a shelf-stable, low-pH processed cheese sauce that retains the good taste and appearance qualities after it is combined with a potato or rice product.

It is a further object of the current invention to provide a nonrefrigerated shelf-stable meal that is economical to produce and provide good nutrition.

Other objects, features, and advantages of the present invention will be apparent from the following summary and description and will be readily apparent to those skilled in the art having knowledge of meals, sauces, and related methods. Such objects, features, benefits, and advantages will be apparent from the above as taken in conjunction with the accompanying examples, tables, data, and all reasonable inferences to be drawn therefrom. It will be understood by those skilled in the art that one or more aspects or embodiments of this invention can meet certain objectives, while one or more other aspects or embodiments can meet certain other objectives. Each objective may not apply equally, in all instances, to every aspect or embodiment of the present invention. As such, considering the relevant art, the objects can be viewed in the alternative with respect to any one aspect or embodiment of the present invention.

### SUMMARY

One aspect of the present invention relates to a shelf-stable meal composition, comprising:
a neutralizing starch component; and
an acidified sauce.

Another aspect of the invention relates to a multi-container meal kit, comprising:
one container comprising a starch product and a neutralizing agent; and
a second container comprising an acidified cheese sauce.

Another aspect of the invention relates to a method of preparing a cooked meal, comprising:
combining a starch product with a neutralizing agent and water to form a neutralizing starch component;
cooking or microwaving the neutralizing starch component; and
adding an acidified sauce to the neutralizing starch component.

### DEFINITIONS

Unless defined otherwise, all technical and scientific terms used herein have the same meaning as commonly understood by one of ordinary skill in the art to which this invention belongs. Still, certain elements are defined below for clarity and ease of reference.

“Shelf-stable” means a food product that is microbiologically and chemically stable at ambient temperature (e.g., without the food product substantially breaking down by, for instance, microbial contamination, syneresis, or water accumulation) without refrigeration or freezing for twelve months.

“Ambient” refers to a temperature in the range of about 65° F. to about 85° F.

“Acidified food” refers to a low-acid food to which acid(s) or acid food(s) are added to produce a product that has a water activity (a_{w}) greater than 0.85 and a finished equilibrium pH of 4.6 or below or meets U.S. regulations governing acidified foods, e.g., 21 CFR 108.25, 110, and 114.

“Low-acid food” refers to a food other than an alcoholic beverage, with a finished equilibrium pH greater than 4.6 and water activity (a_{w}) greater than 0.85, or meet U.S. regulations governing low-acid foods, e.g., 21 CFR 114.

The term “pH” is used to designate the intensity or degree of acidity. The value of pH, the logarithm of the reciprocal of the hydrogen ion concentration in solution, is usually determined by measuring the difference potential between two electrodes immersed in a sample solution.

The term “water activity” (a_{w}) is defined in the book “Food Science, Third Edition, A.V.I. (1984) as a qualitative measure of unbound free water in a system that is available to support biological and chemical reactions. In general, as the water activity of a given food product decreases, its shelf life increases. A high-water activity (a_{w}) product becomes more susceptible to mold, fungus, and bacterial proliferation. For instance, the FDA defines a low-acid food with a pH of greater than 4.6 as shelf-stable only if it has a water activity (a_{w}) of 0.85 or lower. Two foods with the same water content can vary significantly in their water activity depending on how much free water is in the system. When food is in moisture equilibrium with its environment, the water activity of the food will be quantitatively equal to the relative humidity in the headspace of the container divided by 100.

Percentages (%) of ingredients of the compositions are expressed as a weight unit of ingredient in a total of 100 weight units of the composition.

While the numerical parameters setting forth the scope of the disclosed subject matter are approximations, the numerical values set forth in the working examples are reported as precisely as possible. Any numerical value, however, inherently contains certain errors necessarily resulting from the standard deviation found in its respective testing measurements.

### DETAILED DESCRIPTION

The invention summarized above is more particularly described below. Both the descriptions and examples are intended as illustrations only, as numerous modifications and variations consistent with this invention will be apparent to those skilled in the art having knowledge of it. Throughout the specification and claims, percentages are by weight and temperatures in degrees Fahrenheit unless otherwise indicated.

### MEAL COMPOSITIONS

One aspect of the present invention relates to a shelf-stable meal composition comprising: 1) a neutralizing starch component; and 2) an acidified sauce.

In some embodiments, the neutralizing starch component and the acidified sauce are present at a ratio of about 5:1 to about 1:2.

In some embodiments, the neutralized starch component and the acidified sauce are packaged separately in individual containers to be combined by the consumer when preparing the meal for consumption. When combined, the starch component neutralizes or raises the pH of the acidified sauce, thereby eliminating any sour taste in the prepared meal. Since neutralization occurs upon preparation, the invention allows for shelf-stable and economical sauces with high moisture content.

### 1) Neutralizing Starch Component

The neutralizing starch component is a starch product that can increase the pH of the acidified sauce when combined with the starch component.

In some embodiments, the neutralizing starch component comprises a starch product, and a neutralizing agent.

### A) Starch Product

The starch product may be any dry food product that contains starchy carbohydrate. Starchy carbohydrates are mainly found in grains, such as wheat, barley, and rice, as well as in starchy vegetables, such as potatoes and yams. As used in the present invention, the starchy carbohydrate may be in any form, shape, or size, such as whole grain, flour, meal, bran, starch, dehydrated flake, or granule.

Starch is an important structural component in many foods. The starch is present in the form of granules that are insoluble in water at room temperature. Most starches consist of a mixture of two polysaccharides, amylose, and amylopectin at various ratios depending on the origin. The molecular weights and the fine structure of amylose and amylopectin vary with the botanical source. Heating starch granules in an excess of water results in melting of starch granules. This phenomenon, called as gelatinization, depends upon temperature, amount of water present, and agitation during heating. During melting of starch granules, the granules swell to many times their original size depending upon available space. These changes in starch granules are accompanied by separation of amylose and amylopectin, which results in the leaching of amylose out of granules.

In some embodiments, the starch product is macaroni, commonly called and referred herein as “pasta.” Pasta is a class of food prepared by drying formed units of dough that are traditionally made from semolina flour, durum flour, and/or farina flour. For the pasta in the present invention, the traditional flour ingredients may optionally be combined or substituted with one or more ingredients selected from other wheat flours, bran flours, starches, whole grains, rices (e.g., brown, white, short-grain), vegetables (e.g., potatoes, beets, carrots, artichokes, beans, chickpeas, cauliflowers, onions, celeries, garlics, bay leaves), eggs (e.g., egg whites, frozen egg whites, dried egg whites); salt; gums; glutens; instantizing agents (e.g., glycerol monostearate). The flours used may be enriched, fortified, or unenriched.

The pasta may be of any shape and size, including without limitation those associated with spaghetti, vermicelli, fettuccine, linguine, pappardelle, cavatappi, fusilli, rotini, elbow, farfalle, gemelli, penne, rotelli, and orzo. One skilled in the art would appreciate that the shape and wall thickness of the starch product may impact its cooking time, water absorption, and sauce coverage.

In some embodiments, the pasta comprises wheat flour blended with one or more starch(es) (e.g., acorn, native or modified corn, potato) and/or bran flour(s) (e.g., lupine, rice, tapioca, stabilized rice). The use of bran flour may enhance the consumption of whole-grain foods, resulting in an improved intake of fiber and other healthy components.

In some embodiments, the pasta further comprises an instantizing agent to allow faster cooking in microwave applications. In some embodiments, the instantizing agent is glycerol monostearate

In some embodiments, the pasta contains less than about 2% fat, about 70-77% total carbohydrates, and about 11-14% protein.

In some embodiments, the pasta is gluten-free. Gluten-free means there is no wheat, rye, or any other gluten-containing grain, but the food can still have grains that have carbohydrates. Gluten-free pasta may be made with gluten-free, high-carb flour, such as rice flour, potato flour, cornmeal, and/or vegetable-based starch.

Any form of rice or rice flour could be utilized in the current invention. There are two major rice varieties: indica (long-grain) and japonica (medium- to short-grain). Both contain two types of starch - amylose (dry starch) and amylopectin (sticky starch) - but their proportions differentiate between long-grain and short-grain rice. Long grain rice contains more amylose (dry starch) and elongates as it cooks into firm separate grains, resulting in a fluffy texture. Medium- to short-grain rice contains more amylopectin (sticky starch) and grows into rounder clingy grains as it cooks, resulting in a soft, tacky texture. Any rice variety could be used in the current invention.

Frozen, refrigerated, and dried potato in any form may be used in the current invention. In some embodiments, the starch product comprises potato starch granules. Potato starch granules consist primarily of two tightly packed polysaccharides, amylose and amylopectin. Amylose, typically about 20-30% of the polysaccharides, is primarily linear but a fraction of amylose is slightly branched. Amylopectin, typically the major component, is extensively branched.

In some embodiments, the starch product is selected from whole grains, flour, meal, and pasta of wheat, rice, potato, beet, carrot, artichoke, bean, chickpea, or cauliflower, and combinations thereof.

### B) Neutralizing Agent

In some embodiments, the neutralizing starch component comprises a neutralizing agent at a sufficient amount to achieve an increase in pH (reduction in titratable acidity) of the acidified sauce, combined with the starch component. Neutralization is a chemical process that converts either an acidic or alkaline substance or solution to a neutral state, meaning a pH of 7 on the pH scale. A neutralizing agent in the context of the current invention means a substance that affects an increase in pH of up to about 5 to about 8, or in some embodiments, about 5 to about 7 in the prepared meal.

In some embodiments, the neutralizing agent is selected from inorganic emulsifiers, edible alkali metal salts, edible alkaline earth metals, and combinations thereof. Suitable inorganic emulsifiers and nontoxic edible alkali metal salt and/or nontoxic edible alkaline earth metal salt may be selected from any edible or food-grade products, including, without limitation: phosphates, citrates, hexametaphosphates, carbonates, aluminum phosphates, pyrophosphates, polyphosphates, oxides, and hydroxides. Examples of other useful water-soluble nontoxic edible alkali metal salts and alkaline earth salts are sodium aluminum phosphate, sodium citrate, potassium citrate, potassium phosphate, calcium citrate, sodium tartrate, sodium potassium tartrate, disodium phosphate, trisodium phosphate, calcium carbonate, sodium carbonate, sodium hydroxide, potassium hydroxide, and aluminum hydroxide. Dry or liquid forms of neutralizing agents may be used.

The type and amount of neutralizing agent used depend on the specific meal composition, the level of acidity in the sauce to be neutralized, and the pH desired in the prepared meal. In some embodiments, the neutralizing agent is an inorganic pH raising emulsifier. Examples of such pH-raising inorganic emulsifiers include disodium and trisodium phosphates. In some embodiments, the amount of the neutralizing agent is about 0.05% to about 20% by weight of the neutralizing starch component. In some embodiments, the amount of the neutralizing agent is about 3% to about 40%, or about 3% to about 15%, by weight of the neutralizing starch component. The higher the amount of acid in the sauce, the higher the amount of the pH raising neutralizing agent is required to achieve the desired pH in the prepared meal.

In some embodiments, the neutralizing agent and the starch product are packaged separately, to be combined by the consumer before adding water, cooking the starch product, and then cooking and adding the acidified sauce to the cooked starch product. In some embodiments, the neutralizing chemical agent and the starch product are packaged separately, to be combined by the consumer after adding water to and cooking the starch product, but before adding the acidified sauce. In some embodiments, the neutralizing agent is mixed with the starch product before or during the processing of the neutralizing starch component. For instance, an alkaline agent may be mixed with wheat flour pasta at about 0.1% to about 15% by weight to achieve a higher pH in the final pasta before drying the pasta. Alternatively, a basic pH chemical may be added to wet pasta before drying.

Many microwavable single-serve cups currently in the marketplace use antiboiling agents to reduce boil-over of contents during microwave cooking. If anti boiling agents are not used, a soiled microwave oven may result at the end of microwave cooking, and that would be unacceptable to consumers. Antiboiling agents may include modified food starches, acetylated monoglycerides, mono and diglycerides, medium-chain fatty acids, potassium chloride, salt, and/or maltodextrin.

In some embodiments, the neutralizing agent is mixed with an anti boiling agent and then added to the starch product. In such embodiments, the anti boiling agent mixed with the neutralizing agent and starch product may be packaged together in a container, bag, or pouch. In some embodiments, the container, bag, or pouch is suitable for heating food in a microwave. In some embodiments, the container is a single-serve cup. In some embodiments, the container is a single-serve cup suitable for heating food in a microwave.

### 2) Acidified Sauce

The sauce is the most expensive portion of the meal composition; therefore, it is desirable to provide the most economically feasible sauce with the highest possible quality. In some embodiments, the acidified sauce has a pH of about 4.6 or below or about 3 to about 4.6. In some embodiments, the acidified sauce has a water activity (a_{w}) greater than 0.85. In some embodiments, the acidified sauce complies with U.S. regulations governing acidified foods, e.g., 21 CFR 108.25, 110, and 114.

In some embodiments, the acidified sauce is tomato-based, vegan, or dairy. In some embodiments, the acidified sauce comprises a proteinaceous material and an acidifying agent.

### A) Proteinaceous Material

In some embodiments, the acidified sauce comprises a proteinaceous material selected from dairy products, plant products, and combinations thereof. In some embodiments, the proteinaceous material consists essentially of a dairy product selected from dairy casein, whey protein, and combinations thereof. In some embodiments, the proteinaceous material consists essentially of plant protein selected from tofu, soy curd, pea protein, rice protein, potato protein, cashew protein, almond protein, and combinations thereof. In some embodiments, the proteinaceous material is present at about 0.01% to about 20%, or about 0.2% to about 20%, by weight of the acidified sauce. In some embodiments, the proteinaceous material is present at about 0.01% to about 20%, about 0.01% to about 12%, or about 1% to about 12%, by weight of the acidified sauce. In some embodiments, the acidified sauce is pasteurized. For the reasons discussed above, cheese sauces with low cheese content and correspondingly high moisture content above 60% by weight are desirable. However, until the present invention, preservation of such cheese sauces would require heat treatments such as retort or aseptic processing since the preservation method of Tanaka et al., supra, would be ineffective in cheese sauces of such high moisture content. Using acidification, the present invention provides cheese sauces with a high moisture content of about 65-85% by weight. When combined with the acid canceling effect of the neutralized starch component just before consumption, it overcomes the deficiencies of previous preservation methods. In some embodiments, the sauce is acidified to a pH of about 4.6 or below. At such pH levels, the sauce does not support any proliferation of pathogen growth upon postproduction contamination. In further embodiments, the sauce comprises an antimycotic agent at a sufficient amount to inhibit mold and yeast growth. In some embodiments, the acidified cheese and the neutralizing starch component are packaged separately in different containers to delay the neutralization of the acidified sauce until the meal is prepared for consumption. To produce conventional acidified cheese products, a large amount of acidifying agent would be required to reduce the pH to about or below 4.6, resulting in a sour or pickled taste that would not be accepted or tolerated by consumers unless this default is resolved using the inventive compositions and methods. Higher cheese content in an acidified sauce may require elevated levels of inorganic emulsifiers for proper melting and functionality, thus increasing the amount of acidifying agent needed and accentuating the sour taste. In that case, the amount of neutralizing agent could be adjusted to correspond to the level of acidifying agent used to lower the pH of the sauce. Proteinaceous materials utilized in the invention could be of dairy and/or nondairy origin. Milk proteins are composed of casein and whey proteins. Casein is a phosphoprotein that exists in milk in the form of rather large colloidal particles containing the protein and also considerable quantities of calcium and phosphate and a little magnesium and citrate. These particles can be separated from milk by high-speed centrifugation, leaving the whey proteins and dissolved constituents in solution. Phosphoprotein is commonly referred to as “calcium phosphocaseinate” or “calcium caseinate-phosphate.” Casein can be removed from milk in a number of ways besides high-speed centrifugation. The fundamental definition of casein is operational - it is defined as that protein precipitated from skim milk by acidification to a pH of 4.6 to 4.7. The calcium and phosphate associated with casein in the original particles are progressively dissolved as the pH is lowered until, at the isoelectric point of 4.6 to 4.7 pH, the casein is free of bound salts. A second means of removing casein from milk is by rennet coagulation. The enzyme rennin has the ability to slightly change casein so that it coagulates in the presence of divalent cations such as calcium. This process is used in the preparation of cheese curd. It involves the coagulation of the calcium caseinate phosphate particles as such because the pH does not drop, and colloidal calcium and phosphate are not dissolved. Thus, the product prepared by rennet coagulation has high ash content as compared with acid-precipitated casein. Since they are stabilized by charge, the caseinate particles are extremely sensitive to changes in the ionic environment. They readily aggregate with an increase in the concentration of these ions. Since their equilibrium dispersion in milk is rather precarious, minor changes in salt balance and pH easily upset this equilibrium and tend to destabilize and precipitate the casein particles. Whey proteins are composed of different fractions, mainly lactalbumin and lactoglobulin. Milk contains approximately about 2.5% casein and about 0.6% whey proteins. Casein and casein-containing proteinaceous materials include natural cheeses and dehydrated cheeses, such as cheddar, Monterey Jack, Colby, mozzarella, Romano, Parmesan, cream, and or skim-milk cheeses, may be utilized separately or combined as the proteinaceous material in the acidified cheese sauce. Skim milk, fermented milk, buttermilk, nonfat dry milk, milk protein concentrate, caseinate salts such as sodium and calcium caseinate, rennet casein, whole milk, and dry milk may also be suitable sources for casein and casein-containing proteinaceous materials. Such sources for casein-containing proteinaceous materials can be used alone or combined with other suitable proteinaceous materials. In some embodiments, the acidified sauce comprises dairy casein at about 1% to about 12% by weight of the acidified sauce. If the amount of casein-containing proteinaceous materials is too high, increased amounts of inorganic emulsifiers need to be utilized to solubilize the casein component for proper melting and functionality of the acidified sauce. The aforementioned situation adversely impacts acidity manipulation and becomes problematic in producing acidic or pickled tastes in the acidified sauce. For this reason, the amount of casein-containing proteinaceous materials may be adjusted to control the amount of added acidifying agents and impart an acceptable flavor at the needed pH level of 4.6 or below. It was discovered in the current invention that mixing milk casein with whey protein and plant proteins produces cheese sauces of excellent quality while requiring lower levels of acidifying agent addition. Plant proteins such as tofu, soy curd, pea protein, rice protein, potato protein, cashews protein, almond protein, and other vegetable and nut proteins may also be used in the present invention. Vegetable and nut protein with low buffering capacity does not require a high level of acidifying agent addition and may be used alone or in conjunction with casein and/or whey protein. In some embodiments, the acidified sauce comprises dairy casein and/or whey protein and a plant protein, wherein the plant protein is present at about 0.2% to about 20% by weight of the acidified sauce.

### B) Acidifying Agent

Acidifying agents may be used in the present invention to control the pH of the acidified sauce. In some embodiments, the acidifying agent is present at a sufficient amount to provide the acidified sauce with a pH of about 4.6 or below. The amount of acidifying agent may vary according to the amount of cheese, casein, casein-containing proteinaceous material, whey protein, and the type and amount of inorganic emulsifiers used.

Any food-grade acid can provide the necessary pH reduction or control. Organic acids (e.g., acetic, adipic, citric, malic, lactic, succinic, ascorbic, benzoic, erythorbic, propionic, sorbic, tartaric, glucono delta-lactone acid) and inorganic acids (e.g., phosphoric, sulfuric, hydrochloric acid) can also be used alone or in combination to achieve the proper acidification. In some embodiments, the acidifying agent is an organic acid. In some embodiments, the acidifying agent is lactic acid. In some embodiments, the acidifying acid is present at about 0.1% to about 3.5% by weight of the acidified sauce. In some embodiments, the acidifying agent is present at about 0.2% to 2.0% by weight of the acidified sauce.

In some embodiments, the acidifying agent is selected from naturally and artificially acidified products and food products. Nonlimiting examples of such products include sour cream, yogurt, buttermilk, acid whey, and fermented dairy products in any physical form (e.g., dry, liquid, paste). In some embodiments, the acidifying agent is acid whey. In some embodiments, the acid whey is present at about 2% to about 15% by weight of the acidified sauce. In some embodiments, the acidifying agent is yoghurt. In some embodiments, the yogurt is present at about 1% to about 6% by weight of the acidified sauce.

Other ingredients with pH-lowering properties may also be used as the acidifying agent. In some embodiments, the acidifying agent is monosodium phosphate. In some embodiments, the acidifying agent is sodium bisulfate.

The acidifying agent may be added at any stage of the processing of the acidified sauce. In some embodiments, the acidifying agent is added near the end of pasteurization at about 160°-170° F. or after cooling to ambient temperature.

### C) Specific Embodiments, Additional Optional Ingredients

In some embodiments, the acidified sauce comprises cheese at about 10% to about 30% by weight of the acidified sauce. In some embodiments, the acidified sauce further comprises one or more additional solid ingredients, such as natural preservatives, lipids, emulsifiers, salts such as phosphate salts and sodium chloride, and flavors. In some embodiments, the acidified sauce further comprises one or more additional ingredients, such as fillers, texture additives, lactic acid, sorbic acid, and coloring agents.

Cheese sauces of the present invention can be formulated to imitate any cheese flavoring such as cheddar cheese, white cheddar cheese, Italian cheese blend, nacho cheese, and the like. The flavor profile and cheese solids used in the cheese sauce compositions of the present invention depend on the final use of the cheese sauce when combined with the neutralized starch component. Real block cheese, such as cheddar cheese, can be used, for example, when producing a cheddar cheese sauce or the like.

As described above, cheese sauces do not have any standards of identity, meaning that they do not require specific cheese or dairy solid content to be identified as a cheese sauce. In some embodiments of the invention, dairy solids are present in the amount of about 5% or less by weight of the cheese sauce. In some embodiments, casein and whey protein solids are present in the amount of about 4% to about 20% by weight of the cheese sauce.

To compensate for the lower levels of cheese solids than current cheese sauce formulations, dairy solids other than cheese that are lower in cost than cheese can be added to the cheese sauce. Dairy solids, such as buttermilk and whey, and any other variety of dairy solids and combinations thereof can be used. In some embodiments of the invention, dairy solids comprise nonfat milk solids, such as nonfat dry milk, rennet casein, milk protein concentrate, and any other variety of nonfat milk solids and combinations thereof.

The viscosity and total moisture content of the cheese sauce depend on the amount of water in the cheese sauce. Water can also be present in the form of condensate, such as, for example, from steam used in the pasteurization process. In some embodiments of the invention, water is present at about 40% to about 80% by weight of the cheese sauce. In some embodiments, the total moisture content ranges from about 55% to about 67% by weight of the cheese sauce. One advantageous feature of the current invention is that high water content may be incorporated without impacting the safety, shelf-life, or quality of the sauces. Obviously, water is the least expensive component that could be added to reduce the production cost of the cheese sauce and, accordingly, the final meal. With the present invention, a high moisture level of about 70% to about 80% by weight of the cheese sauce could be achieved without compromising on safety, shelf-life, or quality. Additionally, increasing moisture content reduces the viscosity of the cheese sauce, thus allowing easier handling, processing, and filling.

Because of the acidified sauce’s low pH of about 4.6 or below, the amount of added salt (sodium chloride) is not crucial for preservation. Salt may be added at any amount that provides a desirable taste.

In some embodiments, the cheese sauce further comprises an oil to create an emulsion with the water. Suitable oils include, for example, soybean oil, canola oil, vegetable oil, olive oil, palm oil, peanut oil, butter oil, hydrogenated fats, and combinations thereof. In some embodiments, the oil is low-trans or trans-free, such as soybean oil, canola oil, and blends thereof. Such oils have the benefit of having lower levels of saturated fat than standard cheese sauces with higher cheese content (natural cheese can be high in saturated fat). In some embodiments, the oil is canola oil. In some embodiments, the oil is present at about 2% to about 35% by weight of the cheese sauce.

In some embodiments, the acidified sauce further comprises a texture modifier to impart desirable textural properties. The texture modifier may be selected from food-grade texture enhancing agents, including but not limited to gums, hydrocolloids, carbohydrates, and combinations thereof.

In some embodiments, the acidified sauce further comprises a filler. Suitable additive fillers can include additives used to dilute or bulk up food, such as corn syrup solids, dextrin, and maltodextrins. In some embodiments, the filler is selected from corn syrup solids, maltodextrins, and combinations thereof. In some embodiments of the invention, the fillers present at about 0.1 % to about 15% by weight of the acidified sauce. In some embodiments, the filler has a 1:1 blend of corn syrup solids and maltodextrin at about 5% to about 10% by weight of the acidified sauce.

Other texture additives or fillers include gums which help to control the viscosity of the cheese sauce. A suitable gum can be mixed into the formulation, which interacts with and stabilizes proteins in the sauce formulation. Further, a suitable gum should have minimal effect on the pH of the cheese sauce formulation. Suitable gums can include, for example, sodium alginate, guar gum, xanthan gum, carrageenan, and any of a variety of suitable gums and combinations thereof. In some embodiments of the invention, a gum system is present in a range of about 0.1% to about 5% by weight of the cheese sauce. In some embodiments, the gum system includes a combination of sodium alginate and xanthan gums.

One or more additional stabilizers, such as starch, can be included. Starch may be any natural, unmodified, or modified food-grade starch. Starch in the amount of about 0.05% to about 8%, or about 4%, by weight of the cheese sauce, may be used in the invention. Examples of suitable food-grade starches include corn, wheat, sorghum, rice, casaba, potato, tapioca, arrowroot, sago palm, and combinations thereof. In some embodiments, the starch is corn starch or a mixture of corn starches. In some embodiments, the starch is pregelatinized (modified) waxy maize starch.

The cheese sauce is essentially an emulsion of water and oil, as described above. Emulsifiers, such as, for example, mono- and di-glycerides, can be added to the cheese sauce to provide emulsion stability. Emulsion stability impacts shelf-life. Shelf-life includes providing a shelf-stable emulsion for at least twelve months. In some embodiments of the invention, the cheese sauce comprises at least one emulsifier. In some embodiments, at least one emulsifier is present at about 0.1% to about 5% by weight of the cheese sauce.

The pH value of the cheese sauce is important to balance bacterial and pathogen growth with desirable texture and/or taste. For example, if the cheese formulation is too acidic, the cheese sauce may have a sour, undesirable taste or even exhibit curdling. The pH can be manipulated in any of a variety of ways, such as, for example, by the addition of acids, salts, phosphate salts and/or sorbic acid, and the like. In some embodiments of the invention, the pH value of the cheese sauce is about 4.6 or below. In some embodiments, the pH value of the cheese sauce is about 3.5 to about 4.6.

As mentioned above, phosphate salts may be added to help balance the pH of the cheese sauce, which in turn affects the flavor and texture of the cheese sauce. Furthermore, phosphate salts solubilize proteins in the form of cheese and dairy solids, which in turn function as emulsifiers. A blend of mono- and di-phosphate salts, such as, for example, sodium phosphate, can be used to carefully balance the pH to ensure a high-quality cheese sauce, including desirable taste and texture while inhibiting pathogen and bacterial growth. In some embodiments of the invention, the cheese sauce further comprises mono- and di-sodium phosphates. In some embodiments, the mono- and di-sodium phosphates are present at about 0.2% to about 5% by weight of the cheese sauce. In some embodiments, the ratio of di-sodium phosphate to mono-sodium phosphate is at least 1 to 2.

Even when an emulsifier is added when making the cheese sauce, that does not negate the need to add a neutralizing agent to the starch product. Emulsifiers added during the processing of the cheese sauce may raise the pH of the cheese sauce during processing to impact emulsification and solubilization of proteinaceous material and is consumed when acid is added to lower the cheese sauce’s pH to about 4.6 or below. The amount of emulsifier may be reduced to reduce the amount of acid added to lower the pH to about 4.6 or lower. Alternatively, no emulsifier is added.

Other salts, such as mineral salts, can be present in the cheese sauce from a variety of sources, including cheese and dairy solids. Additional salt, such as sodium chloride, can be added for flavor and to help regulate the pH of the total formulation. In some embodiments of the invention, sodium chloride is present at about 0.1% percent to about 5% by weight of the cheese sauce. In some embodiments, sodium chloride is present at about 1.8% to about 2.2% by weight of the cheese sauce.

The cheese sauce can also include a savory flavor system. The flavor system may be chosen to imitate a particular flavor profile. Commonly used dairy flavors can include enzyme-modified cheese, enzyme-modified butterfat, liquid flavors, dry flavors, and flavor pastes. Additional flavors can include spices, for example, garlic powder, onion powder, tomato powder, cumin powder, chili powder, monosodium glutamate (MSG), purees such as jalapeno, onion, parsley, or garlic purees, green, red, and jalapeno peppers, black pepper, sugar, and any of a variety of suitable flavors and combinations thereof. In some embodiments, a flavor system is present at about 0.1% to about 10% by weight of the cheese sauce.

Useful anti-microbial agents can also be included. Acceptable anti-microbial agents include sorbic acid, propionic acid, lactic acid, benzoic acid, and their derivatives. Sorbic acid can be added, for example, as a yeast or mold inhibitor to extend shelf-life stability. In some embodiments of the invention, sorbic acid is present at about 0.01% to 1% by weight of the cheese sauce. Anti-microbial agents can but do not have to be incorporated in the cheese sauce. The cheese sauce does not have to include anti-microbial agents, but it may be incorporated to retard the activity of molds and yeasts after opening the cheese sauce’s container.

In some embodiments, the cheese sauce further comprises about 0.1 to 0.5%, or about 0.1%, by weight of a natural or artificial food colorant. Any certified food colorant used can be chosen to provide the exact shade desired in the cheese sauce.

Consumers with digestive issues who may be sensitive to high acid foods and children can benefit from the inventive products. Acidic tomato sauces such as marinara sauce are neutralized when combined with the neutralizing starch components of the current invention. The resulting product is a mild-tasting meal without harsh sour or acidic notes.

### D) Preparation Methods

The acidified sauce may be prepared by mixing liquid ingredients, such as cream, water, milk, and the like, with soluble solids such as salt, whey protein concentrates, emulsification agents such as phosphates or citrates, colorants, flavorings, spices, gums, starches, or other thickeners, and possibly antimycotics such as potassium sorbate or the like. The resulting mixture is blended and heated while cheese is added with the aid of a scraped-surface mixing kettle or process cheese cooker. The ingredients are agitated until the mixture is smooth. Following mixing of the ingredients, the cheese mixture is heated to a processing temperature of about 160° F.-190° F. for about 2-5 minutes until the ingredients are blended into a smooth paste. Acidifying agents are then added. Preparation methods are described in greater detail in the examples that follow. An advantage of the invention is that the shelf-stable acidified cheese sauce’s high moisture facilitates and accelerates the cooking step. The resulting acidified cheese sauce may be packaged in glass or plastic containers, pouches ranging from about 10 g to about 500 g capacity, totes, or food service bags.

### MEAL KITS

Another aspect of the present invention relates to a multi-container meal kit, comprising:
one container comprising a neutralized starch component;
a second container comprising an acidified sauce.

In some embodiments, the neutralized starch component comprises a starch product and a neutralized agent. In some embodiments, the acidified sauce comprises cheese. In some embodiments, the acidified cheese sauce has a pH of about 3 to about 4.6. In some embodiments, the neutralizing agent is present at about 0.2% to about 10% by weight of the kit. In some embodiments, the starch product is present from about 40% to about 80% by weight of the kit. In some embodiments, the acidified cheese sauce is present from about 10% to about 60% by weight of the kit.

Once the components of each container are produced separately, they may be combined into one final package, box, or single-serve container. For single-serve units, about 40 g starch product may be blended with about 0.5 g to about 5.0 g neutralizing agent in a 200 g capacity polypropylene plastic cup, then the sauce in a 30 g capacity pouch is placed on top, and the cup is sealed. To prepare for consumption, the top seal of cup is removed, the acidified sauce pouch is put aside, about 130 g to about 160 g of water is added to the cup that includes the neutralizing starch component, the cup is microwaved for about 2 to 4 minutes, after which the cup is removed from the microwave and the contents of the sauce pouch are added and blended to provide a tasty meal. Various sizes of family packages may be produced according to the current invention. Based on the required number of servings, the above-mentioned weights may be multiplied by any factor to serve the required number of consumers. In some embodiments, the starch product is mixed with the neutralizing agent and filled into packaging containers such as pouches. To prepare the meal, the pouches may be placed in a cooking pot, then water is added to the pot, and the contents are cooked (e.g., by heating on a stove or in a microwave) until done, the sauce pouch is opened, and the sauce is added to and blended with the high pH, cooked starch component. Alternatively, neutralizing starch components may be placed in a perforated pouch, the pouch is placed in a pot of water and heated until the contents are cooked, then emptied into a serving container, and the acidified sauce is blended in. The neutralizing starch component may be mixed with the acidified sauce in many ratios to deliver desirable products. For instance, a ratio of 5 parts neutralizing starch component may be mixed with 1 part of the acidified sauce. In some embodiments, a ratio of 1 part neutralizing starch component is mixed with 2 parts of acidified sauce. The neutralizing starch component may be cooked to various levels of tenderness or consistency and then mixed with one part of the acidified sauce.

### METHODS OF USE

Other aspects of the present invention relate to methods of using the inventive meal compositions or meal kits.

One such aspect relates to a method of preparing a cooked meal, comprising:
(a) combining a starch product with a neutralizing agent and water to form a neutralizing starch component;
(b) cooking or microwaving the neutralizing starch component; and
(c) adding an acidified sauce to the neutralizing starch component.

With respect to the methods, compositions, or products of the present invention, the various ingredients, components, or materials, whether or not in the amounts or concentrations expressed is compositionally distinguishable, characteristically contrasted, and can be practiced in conjunction with the present invention separate and apart from any other such component, ingredient, or material. Accordingly, it should be understood that the inventive methods and/or compositions, as illustratively disclosed herein, can be practiced, or utilized in the absence of anyone component, ingredient, material and/or step, which may or may not be disclosed, referenced, or inferred herein, the absence of which may or may not be specifically disclosed, referenced, or inferred herein.

### EXAMPLES

The following non-limiting examples and data illustrate various aspects and features relating to the inventive products and/or methods described herein, including the surprising and unexpected results obtained through the use of a neutralizing starch component combined with an acidified sauce component to produce a shelf-stable meal that is convenient and inexpensive to make, nutritious and delicious.

### Example 1

To illustrate the formulation of an acidified cheese sauce, the following ingredients were combined in a 20-pound capacity cooking vessel:

| Ingredient | Weight % |
|---|---|
| Cheddar Cheese | 20 |
| Canola oil | 12 |
| Disodium Phosphate | 2.5 |
| Salt | 2.4 |
| Potassium Sorbate | 0.2 |
| Mono & Diglycerides | 0.6 |
| Xanthan Gum | 0.3 |
| Cheese color | 0.2 |
| Enzyme Modified Cheese | 1.2 |
| Lactic Acid | 2.3 |
| Added Water | 58.3 |

After mixing, the ingredients were heated to 160° F. 100 g of the resulting cheese sauce was filled into pouches, then cooled down to 70° F. Chemical analysis of the sauce was conducted, and the following parameters were recorded:

| Ingredient | Weight % |
|---|---|
| Salt | 2.81 |
| Moist | 64.84 |
| pH | 4.50 |
| Fat | 19.47 |
| Protein | 5.02 |

The amount of lactic acid required to lower the pH to 4.5 was 2.3% by weight of the sauce.

When the sauce was mixed with cooked pasta without any neutralizing agent, it tasted very sour. When the same sauce was mixed with cooked neutralized pasta with a pH of 8.34, the final pH of the meal was 5.94 and sour notes were significantly reduced as illustrated in Example 4.

### Example 2

To illustrate the impact of incorporating higher amounts of cheese and nonfat dry milk on sour taste perception, the following ingredients were combined in an 800-pound capacity cooking kettle:

| Ingredient | Weight % |
|---|---|
| Cheddar Cheese | 30 |
| Nonfat Dried Milk | 2 |
| Canola oil | 12 |
| Disodium Phosphate | 2.8 |
| Salt | 2.8 |
| Potassium Sorbate | 0.2 |
| Mono & Diglycerides | 0.6 |
| Xanthan Gum | 0.3 |
| Cheese color | 0.2 |
| Enzyme Modified Cheese | 1.2 |
| Lactic Acid | 2.7 |
| Added Water | 45.2 |

After blending and heating to 160° F., 100 g of the resulting cheese sauce was filled into pouches, then cooled down to 70° F. Chemical analysis was conducted, and the following parameters were recorded:

| Ingredient | Weight % |
|---|---|
| Salt | 3.4 |
| Moist | 55.64 |
| pH | 4.55 |
| Fat | 22.78 |
| Protein | 8.16 |

The amount of lactic acid required to lower the pH to 4.49 or below was 2.7% by weight of the sauce.

When the sauce was mixed with cooked pasta, it tasted sour, but when the sauce was mixed with cooked neutralized pasta that had a pH of 8.52, the final pH of the cooked meal was 7.05, and there was no astringency or acidic aftertaste observed. As the amount of cheese is increased, more acid is needed to achieve pH below 4.6, and consequently, more neutralizing agents need to be added to the pasta to reduce the sour taste in the final product.

### Example 3

A vegan acidified shelf-stable processed cheese sauce that does not contain any dairy component was formulated as follows:

| Ingredient | Pea Protein % | Ingredient | Pea Protein % |
|---|---|---|---|
| Pea Protein Concentrate (60%) | 7.1 | 0 | 0 |
| Almond Flour | 0 | 20 | 0 |
| Cashew Flour | 0 | 0 | 22 |
| Canola oil | 18.6 | 8.6 | 8.6 |
| Disodium Phosphate | 2.5 | 2.5 | 2.5 |
| Salt | 2.8 | 2.8 | 2.8 |
| Potassium Sorbate | 0.2 | 0.2 | 0.2 |
| Mono & Diglycerides | 0.6 | 0.6 | 0.6 |
| Xanthan Gum | 0.3 | 0.3 | 0.3 |
| Cheese color | 0.2 | 0.2 | 0.2 |
| Vegan Cheese Flavor | 1.2 | 1.2 | 1.2 |
| Lactic Acid | 1.5 | 2 | 1.5 |
| Added Water | 65 | 61.6 | 60.1 |

1,000 g of this formulation was processed in an experimental processed cheese cooker at 185° F., then filled into glass jars and cooled down to 75° F. When chemical properties were determined, the following values were obtained:

| Ingredient | Pea Protein % | Ingredient | Pea Protein % |
|---|---|---|---|
| NaCl | 2.8 | 2.8 | 2.8 |
| Moist | 66.69 | 65.54 | 60.54 |
| pH | 4.5 | 4.3 | 3.67 |
| Fat | 19.47 | 19.80 | 14.31 |
| Protein | 4.27 | 4.41 | 1.78 |

When almond or cashew flours were used, lower protein values were obtained due to the fact that almond flour contains 20-22% protein, while cashew flour contains 8-11% protein. The value of pH for cashew protein, 3.67, was the lowest.

The products showed good organoleptic characteristics when mixed with the neutralizing starch components, exhibiting reduced pickled or sour taste that are commonly found in vegan cheese sauces. Even the cashew protein final vegan meal was very acceptable when mixed with neutralized cooked wheat pasta of a pH of 8.9. The final meal had a pH of 5.13 and had an acceptable taste.

### Example 4

To illustrate the impact of the neutralizing agent included in the neutralizing starch component on raising the pH of the acidified sauce and prepared meal, various amounts of the neutralizing agent were added, and pH was measured after adding water, but before cooking; after cooking; and after adding the acidified cheese sauce. 160 g of water was added to 42 g of pasta in a microwavable cup, and then pH was measured before and after cooking. 26 g of the acidified cheese sauce of Example 1 that had a pH of 4.5 was mixed with the cooked pasta to prepare the meal, and then pH was measured. The same procedures were followed but with the addition of two different levels of disodium phosphate, 2.4 and 3.6 % by weight.

| Disodium Phosphate Weight % | pH Value | | | |
|---|---|---|---|---|
| | Before Cooking | After Cooking | After Sauce | Change |
| 0 | 6.81 | 6.09 | 4.99 | 1.1 |
| 2.40 | 8.23 | 7.48 | 6.31 | 1.17 |
| 3.60 | 8.30 | 7.63 | 6.41 | 1.22 |

As illustrated, cooked pasta without a neutralizing agent has a pH of 6.09 but drops to 4.99 after adding the cheese sauce. The final product tasted acidic and unpleasant.

With a 2.4% by weight neutralizing agent, the uncooked pasta with water had a higher starting pH, while the cooked pasta with the neutralizing agent had a pH of 7.48, which dropped to 6.31 after adding the cheese sauce. The final meal tasted pleasant and did not exhibit any sour or astringent taste.

With a 3.6% by weight neutralizing agent, the uncooked pasta with water had the highest starting pH, while the cooked pasta with the neutralizing agent had a pH of 7.63, which dropped to 6.41 after adding the cheese sauce. The final meal tasted pleasant and did not exhibit any sour or astringent taste.

It should be noted that the pasta absorbed an acid-neutralizing agent inside its structure as it was transformed during the cooking process. The pH drops when comparing before and after cooking the pasta were 0.6 to 0.8. Those changes in pH elucidate the possibility of cooking large quantities of pasta in large cooking pots, draining the excess water, and then adding acidified cheese sauce to prepare food service meals out of large, packaged meal kits.

It was observed that the delta changes in the neutralized cooked pasta before and after acidified sauce addition was 1.1 to 1.22 for all treatments. That discovery indicates that the starting pH of the pasta is the determining factor for acid sensation after adding an acidified sauce. Various levels of neutralizing agents added to pasta before or after cooking the pasta may be manipulated in order to provide selected pH values after the addition of the acidified sauce and impact sour taste perception by consumers.

### Example 5

Antiboiling agents that include a neutralizing agent were developed to illustrate the flexibility of adding neutralizing agents to the starch product at various occasions during the manufacturing or preparation process of the dry neutralizing starch components.

| Ingredient | A % | B % | C % |
|---|---|---|---|
| Modified Food Starch | 54 | 42 | 40 |
| Salt | 19 | 18 | 20 |
| Acetylated Monoglycerides | 10 | 8 | 9.5 |
| Medium Chain Fatty Acids | 5 | 0 | 0 |
| Potassium Chloride | 12 | 12 | 12 |
| Disodium Phosphate | 0 | 20 | 17 |
| Sodium Hydroxide | 0 | 0 | 1.5 |

Formulation A is an example of conventional anti-boiling agents utilized in the marketplace. Formulations A and B are illustrations of the inventive anti-boiling compositions. 3.0 g to 12.0 g of the anti boiling agent may be added to 30.0 g to 60 g of the starch product to form the neutralizing starch components to be mixed with the acidified sauces.

### Example 6

Gluten-free and vegetable-based pastas were combined with a neutralizing agent to form the neutralizing starch components, specifically pasta. The pasta evaluated includes gluten-free pastas such as whole grain, brown rice, high-starch, short-grain rice, potato, beet, carrot, artichoke, beans, chickpeas, and cauliflower pasta.

40 g of each pasta type was mixed with 1 g dipotassium phosphate in a polypropylene microwavable cup, and 130 g of water was added. After mixing, the cup’s contents were cooked in a microwaved oven at high power for 3.5 minutes. There was remaining water in the cup after cooking, which facilitated the incorporation of sauces. The contents of a pouch of cheese sauce prepared according to Example 3 (26 g) were mixed into the cooked pasta and evaluated organoleptically. The inventive nondairy finished meals showed no signs of astringency or sour taste.

### Example 7

Wheat-based pasta was combined with the neutralizing anti boiling agents to form the neutralizing starch component. 40 g of each pasta type was mixed with a 4 g neutralizing anti boiling agent in microwavable cups, and 130 g of water was added. After mixing, the cup was cooked in a microwaved oven at high power for 3.5 minutes. There was remaining water in the cup after cooking, which facilitated the incorporation of sauces. The contents of a pouch of cheese sauce prepared according to Example 2 (35 g) were mixed into the cooked pasta and evaluated organoleptically. Excellent taste, smooth, creamy texture, and appetizing appearance were observed upon evaluation.

### Example 8

To prepare a tomato sauce flavored meal, elbow-shaped macaroni was combined with the neutralizing anti boiling agent B of Example 5. 50 g macaroni was mixed with 7 g neutralizing anti boiling agent in a microwavable cup, and 120 g of water was added. After mixing, the cup’s contents were cooked in a microwave oven at high power for 3.0 minutes. A commercially purchased marinara sauce was mixed into the cooked macaroni at a ratio of 2 parts macaroni to 1 part marinara sauce. Upon organoleptic testing, an excellent non-sour tomato taste with a slight herbal background was noticed.

### Example 9

Rice and sauce dishes were produced utilizing the current invention. A 50 g blend of whole grain, long-grain, and short/medium grain instant rice was mixed with an 8 g neutralizing agent and 200 g water, then microwaved for 5 minutes. An acidified sauce prepared according to Example 1 (35 g) was added and mixed with a spoon.

### Example 10

Dehydrated mashed potatoes were evaluated as a starch product. 25 g of dehydrated mashed potatoes were mixed with 0.3 g trisodium phosphate and 0.3 g sodium citrate and added to a mug, 180 g of water was mixed in, and the mug’s contents were cooked for 3 minutes in a microwave oven. 40 g of an acidified vegan sauce prepared according to Example 3 was mixed in. The finished products resembled an au gratin dishes but were quick and convenient to prepare.

### Example 11

To prepare a finished meal that has all components blended before cooking, 25 g of dehydrated mashed potatoes were mixed with 0.1 g trisodium phosphate in a plastic cup (0.4% by weight potatoes), and 120 g of water was mixed in, then 40 g of acidified cheese component prepared according to Example 1 was mixed in and cooked for 3 minutes in a microwave oven. The finished product exhibited excellent organoleptic qualities with an oven-baked look on the top of the serving container.

### Example 12

A conveniently cooked family meal was prepared according to the current invention. Dehydrated mashed potatoes were evaluated as the starch product. 200 g of dehydrated mashed potatoes were mixed with 1.1 g dipotassium phosphate and 0.4 g of calcium carbonate in a cooking pot, then 1000 g of water was mixed in and cooked for 10 minutes at medium heat on a regular cooktop. 200 g of acidified cheese prepared according to Example 1 was mixed in. The finished product tasted cheesy without any sour notes and had a good orange color.

While the principals of this invention have been described in connection with specific embodiments, it should be understood clearly that these descriptions, along with the chosen tables and data therein, are made only by way of example and are not intended to limit the scope of this invention, in any fashion. For example, as compared to the prior art, the compositional parameters of the present invention can be modified as described herein as a further basis for distinction over the prior art. In addition, many of the ingredients or components specified in the preceding examples are present and/or utilized to optimize various qualities and characteristics as they may apply to taste, appearance, and/or end-use application. However, it should be understood that other such qualities and characteristics, such as low pH, shelf-stability, and economic advantages, can be achieved as more broadly described herein, without such specified components or ingredients. Other advantages and features of this invention will become apparent from the following claims, with the scope thereof determined by the reasonable equivalence, as understood by those skilled in the art.

What is claimed is:

1. A shelf-stable meal composition, comprising:
a neutralizing starch component; and
an acidified sauce.

2. The composition of claim 1, wherein the neutralizing starch component and the acidified sauce are present at a ratio of about 5:1 to about 1:2.

3. The composition of claim 1, wherein the acidified sauce is present at about 10% to about 70% by weight of the composition.

4. The composition of claim 1, wherein the neutralizing starch component of comprises a starch product and a neutralizing agent.

5. The composition of claim 4, wherein the starch product is selected from whole grains, flour, meal, and pasta of wheat, rice, potato, beet, carrot, artichoke, bean, chickpea, or cauliflower, and combinations thereof.

6. The composition of claim 4, wherein the neutralizing agent is selected from inorganic emulsifiers, edible alkali metal salts, edible alkaline earth metals, and combinations thereof.

7. The composition of claim 4, wherein the neutralizing agent is selected from phosphates, citrates, hexametaphosphates, carbonates, aluminum phosphates, pyrophosphates, polyphosphates, oxides, hydroxides, and combinations thereof.

8. The composition of claim 4, wherein the neutralizing agent is selected from water-soluble sodium aluminum phosphate, sodium citrate, potassium citrate, potassium phosphate, calcium citrate, sodium tartrate, sodium potassium tartrate, disodium phosphate, trisodium phosphate, calcium carbonate, sodium carbonate, sodium hydroxide, potassium hydroxide, aluminum hydroxide, and combinations thereof.

9. The composition of claim 4, wherein the neutralizing starch component further comprises an anti boiling agent in combination with the neutralizing agent.

10. The composition of claim 4, wherein the neutralizing agent is present at about 3% to about 40% by weight of the neutralizing starch component.

11. The composition of claim 1, wherein the acidified sauce comprises a proteinaceous material selected from dairy products, plant products, and combinations thereof.

12. The composition of claim 11, wherein the proteinaceous material is a dairy product selected from dairy casein, whey protein, and combinations thereof.

13. The composition of claim 11, wherein the proteinaceous material is a plant protein selected from tofu, soy curd, pea protein, rice protein, potato protein, cashew protein, almond protein, and combinations thereof.

14. The composition of claim 11, wherein the proteinaceous material is present at about 0.01% to about 12% by weight of the acidified sauce.

15. The composition of claim 11, wherein the proteinaceous material is present at about 0.01% to about 20% by weight of the acidified sauce.

16. The composition of claim 1, wherein the acidified sauce further comprises an acidifying agent selected from acetic, adipic, citric, malic, lactic, succinic, ascorbic, benzoic, erythorbic, propionic, sorbic, tartaric, glucono delta-lactone, phosphoric, sulfuric, and hydrochloric acids; naturally and artificially acidified food products; and combinations thereof.

17. The composition of claim 16, wherein the acidifying agent is present at a sufficient amount to provide the acidified sauce a pH of about 4.6 or below.

18. The composition of claim 1, wherein the acidified sauce further comprises a lipid source and water.

19. The composition of claim 18, wherein the lipid source is selected from coconut oil, palm oil, palm kernel oil, corn oil, cottonseed oil, soybean oil, safflower oil, partially hydrogenated vegetable shortening, animal fat, butterfat, and combinations thereof.

20. The composition of claim 18, wherein the water is present at about 40% to about 80% by weight of the acidified sauce.

21. A multi-container meal kit comprising:
one container comprising a starch product and a neutralizing agent; and
a second container comprising an acidified cheese sauce.

22. The kit of example 21, wherein the starch product is pasta.

23. The kit of example 21, wherein the acidified cheese sauce has a pH of about 3 to about 4.6.

24. The kit of example 21, wherein the neutralizing agent is present at about 0.2% to about 10% by weight of the kit.

25. The kit of example 21, wherein the starch product is present from about 40% to about 80% by weight of the kit.

26. The kit of example 21, wherein the acidified cheese sauce is present from about 10% to about 60% by weight of the kit.

27. A method of preparing a cooked meal, comprising:
combining a starch product with a neutralizing agent and water to form a neutralizing starch component;
cooking or microwaving the neutralizing starch component; and
adding an acidified sauce to the neutralizing starch component.
